(19) United States
(12) Patent Application Publication
(10) Pub. No.: US 2025/0341404 A1
(43) Pub. Date: Nov. 6, 2025

(54) VEHICLE PERCEPTION VISUALIZATION

(71) Applicant: Rivian IP Holdings, LLC, Irvine, CA (US)

(72) Inventors: Vinay Palakkode, Santa Clara, CA (US); Vikram Appia, San Jose, CA (US); Nicholas David Carlevaris-Bianco, Santa Clara, CA (US); James William Vaisey Philbin, Palo Alto, CA (US)

(73) Assignee: Rivian IP Holdings, LLC, Irvine, CA (US)

(21) Appl. No.: 19/078,717

(22) Filed: Mar. 13, 2025

Related U.S. Application Data
(60) Provisional application No. 63/643,404, filed on May 6, 2024.
(60) Provisional application No. 63/652,551, filed on May 28, 2024.

(51) Int. Cl. G01C 21/00; B60K 35/22; G01C 21/36; G06V 10/80; G06V 20/56; G06V 20/58

(52) U.S. Cl. CPC G01C 21/3841; B60K 35/22; G01C 21/3667; G06V 10/806; G06V 20/58; G06V 20/588; B60K 2360/166

(57) ABSTRACT

Perception visualization is provided. A system can receive, from a first plurality of sensors of a first sensor type, first sensor data. The system can receive, from a second plurality of sensors of a second sensor type, second sensor data. The system can generate, based on the first sensor data and the second sensor data, an environmental map. The system can identify, based on the environmental map, a plurality of objects and an indication of a route. The system can classify the plurality of objects and the route. The system can display, based on the classification, of a plurality of first visual representations corresponding to the plurality of objects a second visual representation based on the route.

### CROSS-REFERENCE TO RELATED APPLICATIONS

This application claims the benefit of and priority to U.S. Provisional Application 63/643,404, filed May 6, 2024, and U.S. Provisional Application 63/652,551 filed May 28, 2024, each of which is incorporated by reference it its entirety.

### INTRODUCTION

Vehicles can include various sensors to perceive an environment. The vehicle can navigate or communicate based on sensor data of the sensors.

### SUMMARY

This disclosure is generally directed to systems and methods for perception visualization. For example, the perception visualization can be presented on a graphical user interface of a vehicle based on fused sensor data from multiple sensor sets associated with the vehicle. Each sensor set can include at least one sensor type, such as a radar, ultrasonic, or optical camera. Some or all of the sensor sets can gather 360° coverage around a vehicle. For example, a combination of front, rear, and side cameras can generate a first set of sensors data, which can be transformed to generate a first encoded image. A set of radar, ultrasonic, or other sensors can generate a second encoded image. Some vehicles can include multiple sets of a same sensor type, such as multiple cameras (e.g., long distance and short distance cameras or visual and IR cameras). A vehicle can include any number of sensor sets. For example, an example vehicle can include two sets of cameras and one set of radar sensor/emitter pairs.

A mapper can ingest the encoded images from the various sensor sets, to generate an environmental feature map. The environmental map may sometimes be referred to as either of a feature map or a fused instance of the various encoded images. A decoder can ingest the environmental map and extract various data sets. For example, the decoder can extract object data relating to a position, velocity, or other aspect of a vehicle, pedestrian or other vulnerable road user, pothole, or other objects. The decoder can extract lane data, such as lane marker or road cone information, a center of a lane, or so forth. The decoder can extract traffic control data such as road signs, traffic lights or other traffic control devices, or traffic control data retrieved based on a GNSS or other positional sensor. The system can present of any of the extracted information on a graphical user interface. For example, the system can cause a display of a vehicle in a roadway along with lane markings and paths, and other objects of interest proximal to the vehicle.

In at least one aspect, a system includes one or more processors coupled with memory. The system can receive, from a first plurality of sensors of a first sensor type, first sensor data. The system can receive, from a second plurality of sensors of a second sensor type, second sensor data. The system can generate, based on the first sensor data and the second sensor data, an environmental map. The system can identify, based on the environmental map, a plurality of objects and an indication of a route. The system can classify the plurality of objects and the route. The system can display, based on the classification, of a plurality of first visual representations corresponding to the plurality of objects a second visual representation based on the route.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a system to visualize an environment associated with a vehicle, in accordance with some aspects.

FIG. 2 depicts an electric vehicle, in accordance with some aspects.

FIG. 3 is a top view of a vehicle disposed in an environment, in accordance with some aspects.

FIG. 4 depicts a block diagram for a data flow of the data processing system, in accordance with some aspects.

FIG. 5 depicts a block diagram for a data flow of an output of the data processing system, according to some aspects.

FIG. 6 depicts a graphical user interface, according to some aspects.

FIG. 7 depicts a block diagram illustrating an architecture for a computer system that can be employed to implement elements of the systems and methods described and illustrated herein.

FIG. 8 depicts an example graphical user interface, according to some aspects.

FIG. 9 depicts an example graphical user interface, according to some aspects.

FIG. 10 depicts an example graphical user interface, according to some aspects.

FIG. 11 depicts an example graphical user interface, according to some aspects.

FIG. 12 depicts an example graphical user interface, according to some aspects.

FIG. 13 is an example top view of a vehicle disposed in an environment, according to some aspects.

FIG. 14 depicts an example graphical user interface, according to some aspects.

FIG. 15 is an example top view of a vehicle disposed in an environment, according to some aspects.

FIG. 16 is a block diagram for an example of a data processing system, according to some aspects.

FIG. 17 is a block diagram for an example of a data processing system, according to some aspects.

FIG. 18 is a block diagram for an example of a data processing system, according to some aspects.

### DETAILED DESCRIPTION

Following below are more detailed descriptions of various concepts related to, and implementations of, methods, apparatuses, and systems of a perception system for environmental visualization. The various concepts introduced above and discussed in greater detail below may be implemented in any of numerous ways.

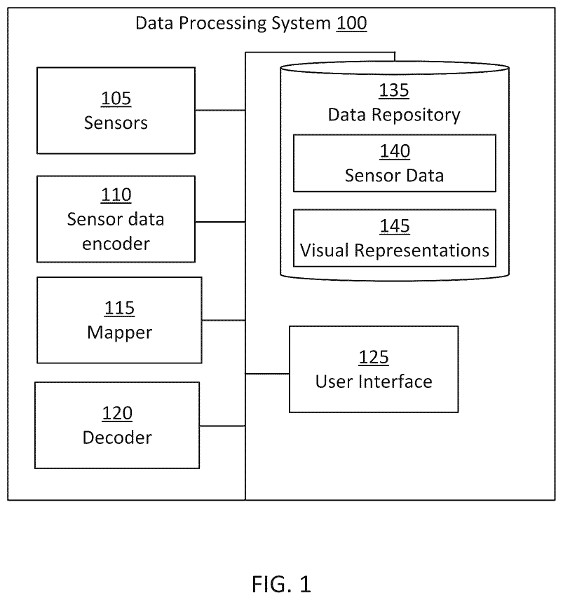

FIG. 1 depicts a system to visualize an environment associated with a vehicle, in accordance with some aspects. The system can include, interface with, or otherwise communicate with a data processing system 100 for a vehicle, such as an electric vehicle. The data processing system 100 can include or be part of (e.g., hosted by) a vehicle. The data processing system 100 can include or interface with various sensors 105 (or sets of sensors 105) to determine a condition of an environment proximal to the vehicle. The data processing system 100 can include or interface with at least one sensor data encoder 110 to encode data from a set of sensors 105. The data processing system 100 can include or interface with at least one mapper 115 to generate a feature map based on multiple encoded images generated by the sets of sensors 105. The data processing system 100 can include or interface with at least one decoder 120 to extract features from the feature map. The data processing system 100 can include or interface with at least one interface including a user interface 125, such as an in-cabin display of a dashboard or center information display (CID).

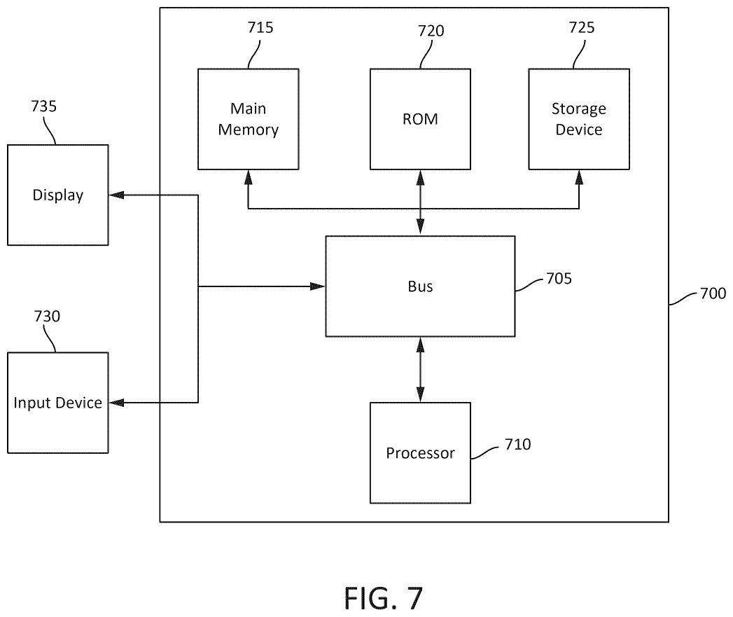

The data processing system 100 can include at least one data repository 135. The sensors 105, sensor data encoder 110, mapper 115, decoder 120, or user interface 125 can each include at least one processing unit or other logic device such as programmable logic array engine, or module configured to communicate with the data repository 135 or database. The sensors 105, sensor data encoder 110, mapper 115, decoder 120, or user interface 125 can be separate components, a single component, or part of the data processing system 100. The data processing system 100 can include hardware elements, such as one or more processors, logic devices, or circuits. For example, the data processing system 100 can include one or more components or structures of functionality of computing devices depicted in FIG. 7.

The data repository 135 can include one or more local or distributed databases, and can include a database management system. The data repository 135 can include computer data storage or memory and can store one or more data structures, such as a data structure corresponding to sensor data 140 or visual representations 145.

Sensor data 140 can refer to or include information received from one or more sensors 105. For example, the sensor data can be grouped according to sets of sensors 105. For example, a first set of cameras can generate first sensor data 140, a second set of cameras (e.g., including different optical cameras than the first set) can generate second sensor data 140, and radar sensor can generate third sensor data 140. Each set of sensor data 140 can include different information. For example, the sensor data 140 associated with the radar can include speed information and sensor data 140 associated with visible spectrum cameras can include color data. Other sensor data can include overlapping and non-overlapping information such as position, luminance, condition, speed, or other aspects of a roadway or objects in or otherwise associated with the roadway.

A visual representation 145 can refer to or include a symbolic representation of an object associated with a vehicular environment. For example, the visual representations 145 can include one or more visual representations 145 for a roadway user such as a car, truck, or vulnerable road user (VRU) (e.g., pedestrian, motorcyclist, bicyclist, or so on). The visual representation 145 can include a depiction of a roadway such as a road marking, barrier, lane width, path of travel, or other aspect. The visual representation 145 can include a traffic control device such as a stop sign, stop light, or road cone. The visual representation 145 can vary from a physical object. A particular visual representation 145 for a vehicle can depict one or more objects of an object class. For example, a first visual representation 145 can depict any of a car, truck, or SUV; a second visual representation 145 can depict another vehicle such as a box truck, semi-trailer, or concrete mixer. Likewise, one or more classes of road makings can correspond to one or more visual representations 145.

Some visual representations 145 can include aspects which correspond to elevated or lowered prominence, such as highlighting, colors, arrows, or descriptive names. Some visual representations 145 can correspond to an ego vehicle (e.g., a vehicle implementing the systems and features provided herein). A visual representation 145 for an ego vehicle can be provided with elevated or otherwise distinguished prominence relative to other objects. For example, the ego vehicle can be presented as a center of a display, or including a color, shape, or other resemblance to the ego vehicle, or other prominence. An object in a path of a vehicle (e.g., a vehicle in a same lane as a vehicle of interest, sometimes referred to as an ego lane), may be presented according to a designated color or other prominence feature.

The data processing system 100 can include or interface with one or sensors 105 configured to sense information associated with an operation of a vehicle or an environment interacting therewith. The sensors 105 can be arranged into sensor sets. Each sensor 105 can include a field of view (FOV), which may overlap with one another to generate continuous senor data 140 associated with a portion of a vehicle. Each sensor set can capture a set of sensor data 140. Some sets of sensors data 140 can surround a vehicle (360° of coverage) or substantially surround a vehicle. A sensor set can include sensors 105 of a like type. For example, a sensor set can include line of sight sensors such as cameras (e.g., visible spectrum cameras). Accordingly, sensor data 140 received from each sensor 105 of a set of sensors 105 can be transformed into an encoding.

The data processing system 100 can include or interface with one or more sensor data encoders 110. The sensor data encoders 110 can generate an encoding from at least one set of sensors 105. An encoding can include a combination of data received by the various sensors. The generation of the encoding can include executing a spatial or other transform, such as a perspective transform. For example, a set of sensors 105 can include sensors disposed substantially along a traveled surface such as a forward-facing camera of an advanced driving assistance system (ADAS), a backup camera, or a blind spot camera. The encoding can apply a transform to generate a top-down view (sometimes referred to as a Birdseye view). Some transforms can vary according to various sensors 105 of a sensor set. For example, a sensor set can include a first camera having a fisheye lens (e.g., a wide-angle backup camera) and a second camera having a balanced (or telephoto) lens, such as a forward-facing camera of an adaptive cruise control (ACC) system.

The sensor data encoders 110 can encode any information embedded in sensor data 140 generated by one or more sensors 105 of a set of sensors 105. For example, the encoded information can include a relative or absolute position, depiction, shape, or other aspect of an object, roadway, or other aspect of an environment. Particular encoded information can depend on a sensor type and position. For example, a radar or LiDAR sensor can generate speed, distance, or transparency information which may be omitted via one or more cameras, or an infrared camera can generate temperature data which may omitted via a radar sensor (e.g., receiver of an emitter-receiver pair).

The data processing system 100 can include or interface with one or more mappers 115. The mapper 115 can ingest the various encodings and generate a feature map according to information embedded in the various encodings. The mapper 115 can implement perspective (e.g., spatial) or other transforms to align data between the various encodings. For example, the mapper 115 can align features from a radar, ultrasonic, image, or other sensor to generate the feature map. The feature map can include information from a combination of sources related to an environment, and accordingly, may be referred to as a “feature map” or “environmental map” without limiting effect.

The data processing system 100 can include or interface with one or more decoders 120. The decoder 120 can decode features from the feature map. The decoders 120 can extract features corresponding to a predefined class, or with a predefined tag. For example, the decoder 120 can decode features corresponding to objects in, of, or otherwise associated with, a roadway, lanes of the roadway, traffic control devices, or other environmental data.

Some features can include objects such as motorized or other vehicles, traffic control devices, lane markings, or paths of travel. The decoder 120 can classify decoded features according to a set of predefined classes to cause a display of a visual representation 145 corresponding to the class. For example, the decoder 120 can determine that extracted features correspond to various vehicles and lanes of travel corresponding to the various vehicles. The decoder 120 can classify an object or other features to determine a visual representation 145 corresponding thereto. For example, the decoder 120 can determine that a VRU corresponds to a visual representation of a bicycle, motorcycle, scooter, or pedestrian. The decoder 120 can update the identification of the visual representations 145. For example, the decoder 120 can periodically update the identification or update the identification based on a trigger. The update of the visual representations 145 can be updated synchronously or asynchronously to other processes, such as the identification a route or an indication of a route, or a determination of navigational intent or an indication of the navigational intent.

The data processing system 100 can include or interface with one or more user interfaces 125. The user interface 125 can include a graphical user interface (GUI). The GUI can include visual representations corresponding to features decoded by the decoder 120. For example, the user interfaces 125 can present a depiction of objects and a roadway. The objects can include any of various vehicle types, road markings, or other visual representations. The classification of the features is not limited to the display via the user interfaces 125. For example, a vehicle can perform navigational actions based on the extracted features, even if those features are not displayed. The navigational actions can include, for example, turn signal indications, lane changes, braking, acceleration, or steering inputs (e.g., steering within an ego lane, between lanes, or outside of marked lanes).

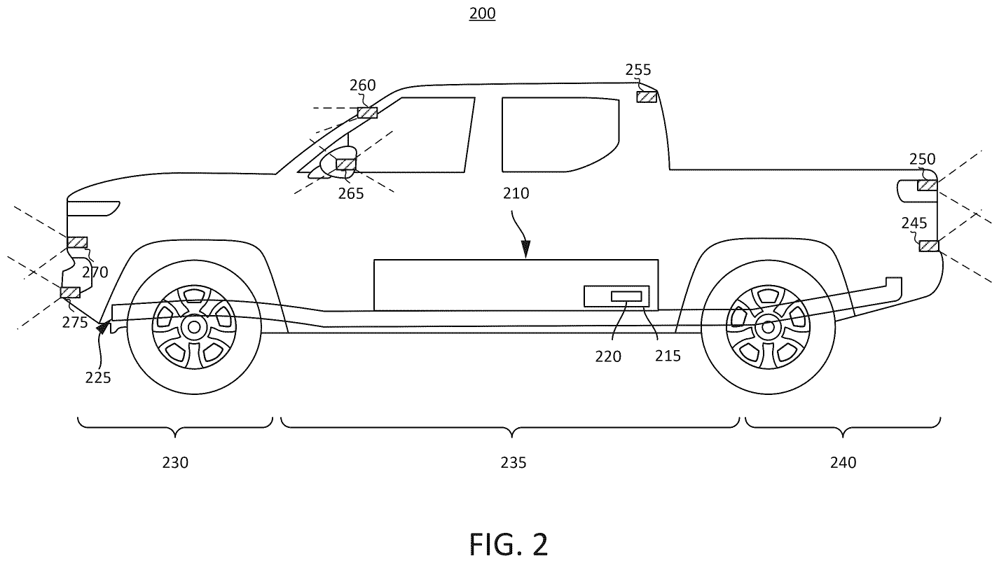

FIG. 2 depicts an example cross-sectional view of an electric vehicle 200 installed with at least one battery pack 210. Electric vehicles 200 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 210 can also be used as an energy storage system to power a building, such as a residential home or commercial building. Electric vehicles 200 can be fully electric or partially electric (e.g., plug-in hybrid) and further, electric vehicles 200 can be fully autonomous, partially autonomous, or unmanned. Electric vehicles 200 can also be human operated or non-autonomous. Electric vehicles 200 such as electric trucks or automobiles can include on-board battery packs 210, batteries 215 or battery modules 215, or battery cells 220 to power the electric vehicles.

The electric vehicle 200 can include a chassis 225 (e.g., a frame, internal frame, or support structure). The chassis 225 can support various components of the electric vehicle 200. The chassis 225 can span a front portion 230 (e.g., a hood or bonnet portion), a body portion 235, and a rear portion 240 (e.g., a trunk, payload, or boot portion) of the electric vehicle 200.

The battery pack 210 can be installed or placed within the electric vehicle 200. For example, the battery pack 210 can be installed on the chassis 225 of the electric vehicle 200 within one or more of the front portion 230, the body portion 235, or the rear portion 240. The battery pack 210 can include or connect with at least one busbar, e.g., a current collector element. For example, the first busbar and the second busbar can include electrically conductive material to connect or otherwise electrically couple the battery 215, the battery modules 215, or the battery cells 220 with other electrical components of the electric vehicle 200 to provide electrical power to various systems or components of the electric vehicle 200.

The electric vehicle 200 can include or interface with one or more sensors 105 configured to monitor the environment associated with the electric vehicle 200. For example, the sensors 105 can include ultrasonics or other time of flight sensor 105 or a camera configured to detect the aspects of an environment associated with the electric vehicle 200.

Each of the sensors 105 can correspond to a FOV, which may be used to refer to a FOV of a camera or other optical sensor, a scan area of a radar emitter/receiver pair, a detection zone of an ultrasonic emitter/receiver pair, or other monitored area associated with a further sensor type. Any of the sensors 105 can be dedicated to the visualization of vehicle perception information, or can be used for any other purpose. For example, the sensors 105 can include a camera or radar used for automatic avoidant braking or ACC, a backup camera, or another sensor. For example, a first sensor 245 can include a reverse camera including at least visible spectrum sensor data 140. A second sensor 250 can include a blind spot sensor implemented according to any sensor type. A further instance of the second sensor 250 may be present on an opposite side of the vehicle, where at least a portion of the sensors are generally symmetrical about a longitudinal axis of the vehicle. A third sensor 255 can include a vehicle positional sensor such as a Wi-Fi, cellular, or global navigation satellite system (GNSS) sensor such as GLONASS or global satellite system (GPS). A fourth sensor 260 can include a wing sensor monitoring a FOV to a side of the electric vehicle 200. A corresponding sensor can be disposed on an opposite side of the electric vehicle 200. A fifth sensor 265 can include a front side-view camera; a sixth sensor 270 can include a front blind spot camera, and a seventh sensor 275 can include an outward facing camera from a vehicle cab, such as a camera used by an automatic avoidant braking or ACC system. One or more sensors (e.g., the fifth sensor 265) can include multiple sensor orientations (e.g., forward facing, rear facing, outward facing) or types (e.g., FOV or sensor types such as visible spectrum cameras, IR cameras, ultrasonics, or radars). For example, a side view mirror or mirror assembly can include three sensors 105 to gather sensor data 140 which is fused by a mapper 115 or otherwise used for the systems and methods described herein. Various electric vehicles 200 can implement any of various sensors. Some electric vehicles can omit any of the depicted sensors or include any further sensors of any sensor type or position.

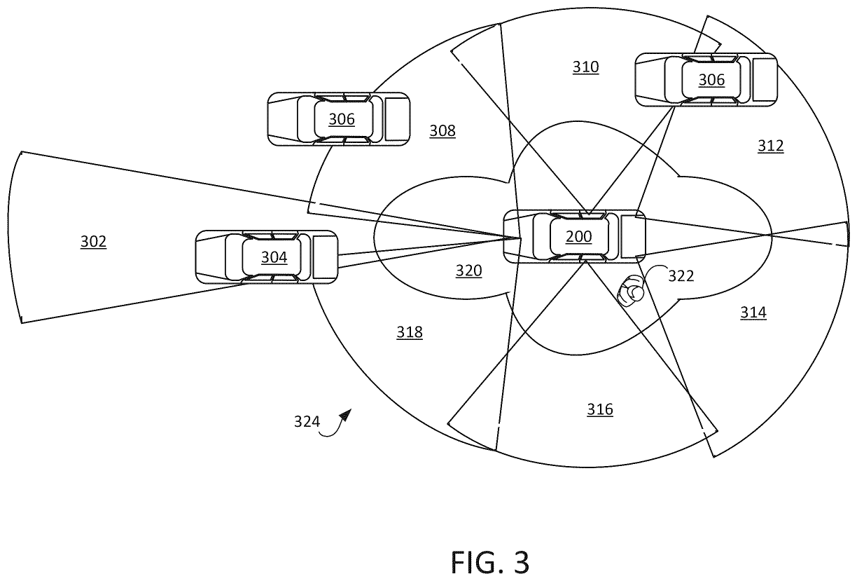

FIG. 3 is a top view 300 of a vehicle (e.g., the electric vehicle 200 of FIG. 2) disposed in an environment, in accordance with some aspects. The view 300 includes fields of view for various sensors of the vehicle. For example, a frontal field of view (FOV) 302 can include objects forward of the vehicle 200, which can include a primary object 304 or various other detected objects 306. A first set of cameras can correspond to a camera capturing the first FOV 302, along with cameras capturing a second FOV 308, third FOV 310, fourth FOV 312, fifth FOV 314, sixth FOV 316, and seventh FOV 318 (collectively, first field of view array 324).

A second set of cameras can capture a second field of view array 320. Further sensor sets, such as radars and ultrasonics, can gather further sensor data. Each sensor or set can capture features not available to other sensors 105 or sets. For example, the second field of view array 320 can detect a VRU 322 not included in a FOV of the first field of view array 324. Further sensor types (e.g., radars or ultrasonics) can detect further features, such as a speed or reflectivity profile of the VRU which can be received by the decoder 120 to determine a classification for the VRU 322. For example, based on ingested features of a shape profile corresponding to a human torso (e.g., received from a camera) in combination with location information corresponding to a pedestrian walkway (e.g., as received by a GNSS), and a speed corresponding to 3 kilometers per hour (kph), the decoder 120 can associate the VRU 322 with a visual representation 145 indicating a pedestrian. According to a different speed or position, the decoder could associate the same shape profile with a bicycle, scooter, or other visual representation 145.

The combination of sensor data prior to feature generation or extraction/decoding (early fusion) can aid in the classification of objects or other aspects of a vehicle environment. For example, the cross-domain (e.g., image/radar) information can improve a performance of a classification or other prediction of an object type. Moreover, the data processing system 100 can continue operation upon a loss of communication or data with one or more sensors or sets of sensors. For example, where a sensor 105 or set of sensors 105 is missing, obscured, or otherwise inoperable for at least a portion of an associated FOV, other sensors of a same or different type can provide information to maintain operation of a system.

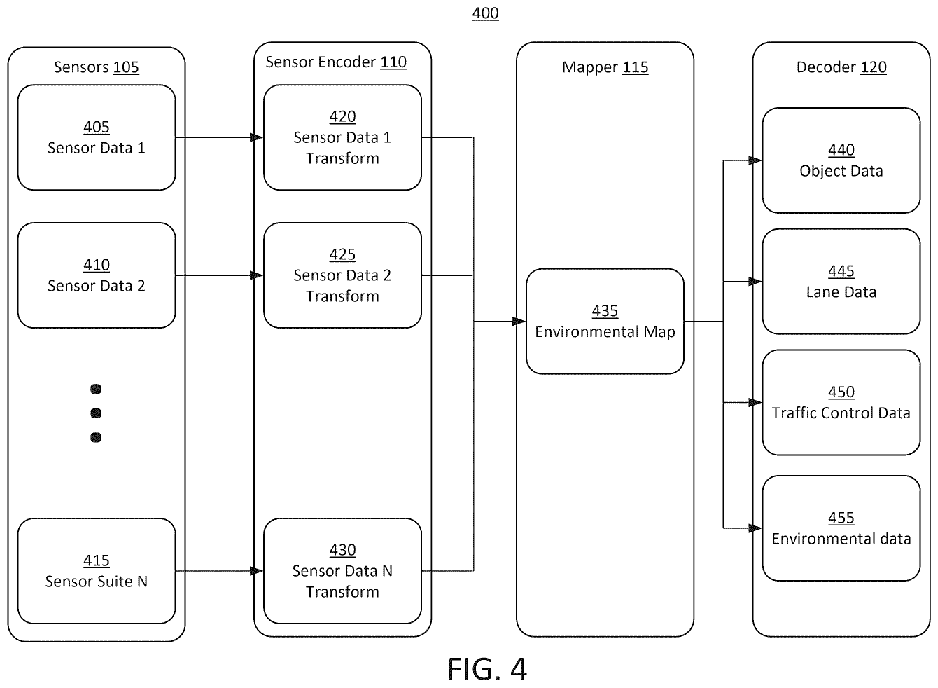

FIG. 4 depicts a block diagram 400 for a data flow of the data processing system 100, in accordance with some aspects. Various sets of sensors 105 can generate sensor data. For example, the sets of sensors 105 can include non-overlapping sets (e.g., where at least one of a first set, second set, or nth set of sensors 105 do not include a same sensor 105 as another of the first set, second set, or nth set of sensors). A first set of sensors 105 can generate first sensor data 405 corresponding to, for example, cameras having a FOV similar to the first field of view array 324 of FIG. 3. A second set of sensors 105 can generate second sensor data 410 corresponding to, for example, cameras having a FOV similar to the second field of view array 320 of FIG. 3. An nth set of sensors 105 can generate nth sensor data 415 of another sensor type, such as radar return data.

The sensor encoder 110 can generate, from each of the sensor sets, an encoding. A first encoding can combine various streams of the first sensor data 405 to generate a first encoding. For example, the sensor encoder 110 can stitch together a narrow field of view (NFOV) forward camera (e.g., corresponding to the frontal FOV 302 of FIG. 3), a left and right wing FOV of a side mirror mounted camera (e.g., corresponding to the third FOV 310 and sixth FOV 316 of FIG. 3) and another region of interest (ROI) FOV. The ROI FOV can include a virtual camera generated from one or more sensors, such as the combination of the fourth FOV 312 and fifth FOV 314 of FIG. 3. In some cases, the combination of sensors can collectively form a 360° FOV around an ego vehicle. The data processing system 100 can combine various streams of the second sensor data 410 to generate a second encoding. The system can continue to operate with visual data based on an absence of either of the first embedding or the second embedding. For example, the first embedding and second embedding may include redundant 360° coverage, or the system can continue to operate lacking 360° coverage (e.g., lacking a rear facing camera when the vehicle is driving forwardly). Additional encodings can combine various streams of their corresponding sensor data to generate additional encodings for any sensors, such as ultrasonic sensors. An nth encoding can combine various streams of the nth sensor data 415 to generate an nth encoding (e.g., radar).

Although the encodings can include overlapping information, the encodings can vary in perspective (e.g., vary from each other or vary from another portion of the data processing system 100. For example, the sensor encoder 110 can execute a spatial transform of an encoding to generate a sensor data transform according to a perspective (e.g., a top-down view such as a Birdseye view, oblique aerial view, or isometric view). Such a transform can aid a fusion of the various encodings into a same feature map. For example, the sensor encoder 110 can transform the first sensor data 405, second sensor data 410 and so on to an nth sensor data 415 to realize a first sensor data transform 420, second sensor data transform 425, and so on to an nth sensor data transform 430. The various transforms can be in a same spatial perspective to aid in the fusion of their various features.

The mapper 115 can fuse the features to generate an environmental map 435 including the various features of the sensor data transforms 420, 425, 430 (which may be referred to as constituent feature maps of the environmental map 435, without limiting effect). The mapper 115 can embed, in the environmental map 435, all of the features of the constituent maps. For example, the environmental map 435 can include position, color, reflectivity, speed, or other information captured by any sensors 105 of or interfacing with the data processing system 100. A subset of features of the environmental map 435 can be used for some purposes. For example, a feature corresponding to a presence of an object in the path of a vehicle can be used for avoidant braking to reduce dependencies on other portions of a model.

A decoder 120 can decode information embedded in the environmental map 435. For example, the decoder 120 can decode object data 440 relating to objects such as road users, barriers, and some traffic control devices (e.g., traffic cones). The decoder 120 can decode lane data 445. For example, the decoder 120 can decode features related to dashed or solid lane dividers, colors of lane dividers, a position of barriers, or other features associated with a path of travel of a vehicle. The decoder 120 can decode traffic control data 450 such as a state of drivable space. The traffic control data 450 can further include information derived from skipped layer connection (e.g., a traffic light color or speed limit sign can be more legible in a non-transformed view, prior to generation of the environmental map 435, or such information can be embedded into the environmental map 435 separately from the spatial transforms 420, 425, 430). The decoder 120 can decode any other environmental data 455 associated with a vehicle, such as an indication of volumetric occupancy of various portions of an environment (e.g., a three-dimensional spatial grid).

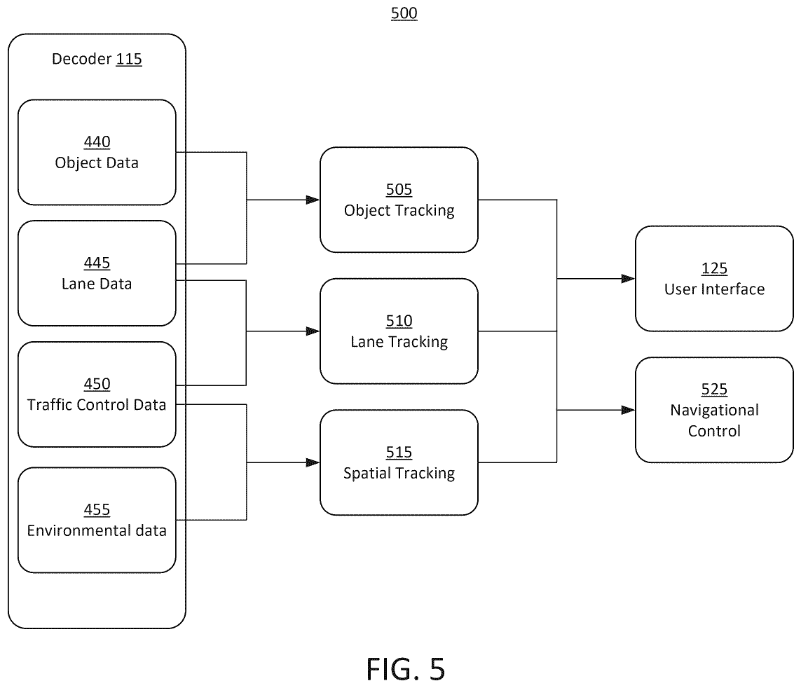

FIG. 5 depicts a block diagram 500 for a data flow of an output of the data processing system 100, according to some aspects. The data flow includes an object tracker 505, lane tracker 510, and spatial tracker 515 of the data processing system 100. The object tracker 505, lane tracker 510, and spatial tracker 515, like other aspects of the data processing system 100, can be implemented according to various circuits as described with reference to, for example, FIG. 1 and FIG. 7.

The object tracker 505 can associate a class or identity with a detected object (e.g., via a 3D box regressor to extract feature embeddings of a vehicle, vehicle type, pedestrian, physical barrier or building, or any other object feature). The object tracker 505 can implement kinematic estimation to estimate a speed or direction of an identified object, and cause a display of a visual representation 145 of the object. For example, the kinematic estimator can implement a smoothing function to reduce jitter and maintain object identities over time (e.g., can implement data filtering or processing for various identified objects). For example, such filtering can validate, subsequent to an identification and prior to the display of the plurality of objects and the indication of the route, a position of the plurality of objects and the route. The validation can include a temporal dependency between the position and a previous position (e.g., to avoid appearance/disappearance of spurious sensor readings).

A lane tracker 510 can determine a position of a lane based on received decoded lane data 445 to determine an ego lane, any adjacent lanes or further lanes of a roadway, or other road boundaries such as a physical barrier or road marking. The lane tracker 510 can identify a visual representation corresponding to the lane. The lane tracker 510 can cause a display of the lane or associated features via a display of a user interface 125. The lanes can further vary according to a drivable space, such as based on other vehicles, obstructions, or road surface conditions. The lane tracker 510 can identify lanes which are not occupied by a vehicle. For example, the lane tracker 510 can identify a bicycle lane, pedestrian walkway (e.g., sidewalk), or so forth.

A spatial tracker 515, such as a grid-based occupancy tracker can identify a spatial occupancy, by the various objects, of an environment. For example, the spatial tracker 515 can subdivide an environment into a two-or three-dimensional grid to determine a path of travel which can, in some instances, deviate from a lane. For example, according to a flow of other vehicles, a path of travel can include exiting and re-entering a lane (e.g., in response to an obstruction of a construction vehicle or deer-strike). The path can further depend on a presence of objects such as road cones or barriers. The spatial tracker 515 can provide a path of travel which can be smoothed or otherwise adjusted over time to avoid discontinuous pathing. For example, the spatial tracker 515 can be provided according to piece-wise polynomial (e.g., cubic) splines. The polynomial may be configured to correspond to a turning radius of the ego vehicle.

Any of the data derived by or available to the object tracker 505, lane tracker 510, or spatial tracker 515, or otherwise by the data processing system 100 can be provided to a user interface 125 for presentation (e.g., visual display via a GUI). Likewise, any of the data may be used to generate or inhibit a navigational action, whether by the data processing system 100 or another component of a vehicle, such as a navigational control component 525. That is, the perception system can be provided for autonomous or semiautonomous systems or for a user combination display. Some data may be provided to the user interface 125 but not to the navigational control component 525; conversely, some data may be provided to the navigational control component 525 but not to the user interface 125.

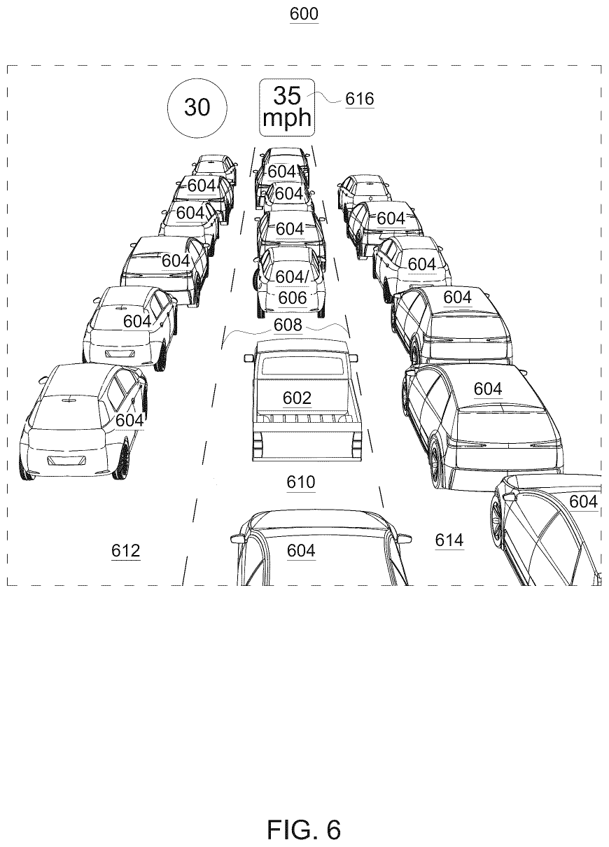

FIG. 6 depicts a display 600 of a graphical user interface 125, according to some aspects. The display 600 can be presented via an instrument cluster display (ICD), center information display (CID), or another display of a vehicle. For example, the systems and methods provided herein can cause a presentment of the GUI for an occupant of an electric vehicle to visualize an environment associated with a vehicle, such as the electric vehicle 200 of FIG. 2.

The display 600 can include an ego vehicle 602 corresponding to a vehicle including the sensors 105 or other aspects of the data processing system 100. The display 600 can include lane markings 608 or other indications of a path of travel (e.g., an off-road trail). The lane markings 608 can define an ego lane 610 and one or more adjacent lanes 612, 614. The data processing system can determine the depicted lanes based on features decoded from the sensors 105 or as received from a stored instance of a map (e.g., based on positional information such as GPS sensor data).

The display 600 can include various further objects including vehicles 604. A subset of the objects can be provided with increased prominence such as a primary object ID 606 (e.g., vehicle 604, which is in a path of travel of the ego vehicle 602, or otherwise most relevant to a path of travel of the ego vehicle 602). The display 600 can include information associated with a traffic control device, such as a display of a vehicle speed relative to a speed limit 616 which can be determined according to the extracted traffic control data 450 or map-derived data).

FIG. 7 depicts an example block diagram of an example computer system 700. The computer system or computing device 700 can include or be used to implement a data processing system 100 or its components. The computing system 700 includes at least one bus 705 or other communication component for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random-access memory (RAM) or other dynamic storage device, coupled to the bus 705 for storing information, and instructions to be executed by the processor 710. The main memory 715 can be used for storing information during execution of instructions by the processor 710. The computing system 700 may further include at least one read only memory (ROM) 720 or other static storage device coupled to the bus 705 for storing static information and instructions for the processor 710. A storage device 725, such as a solid-state device, magnetic disk or optical disk, can be coupled to the bus 705 to persistently store information and instructions.

The computing system 700 may be coupled via the bus 705 to a display 735, such as a liquid crystal display, or active-matrix display, for displaying information to a user such as a user disposed within a cabin of an electric vehicle 200 or exterior to the cabin. An input device 730, such as a button or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

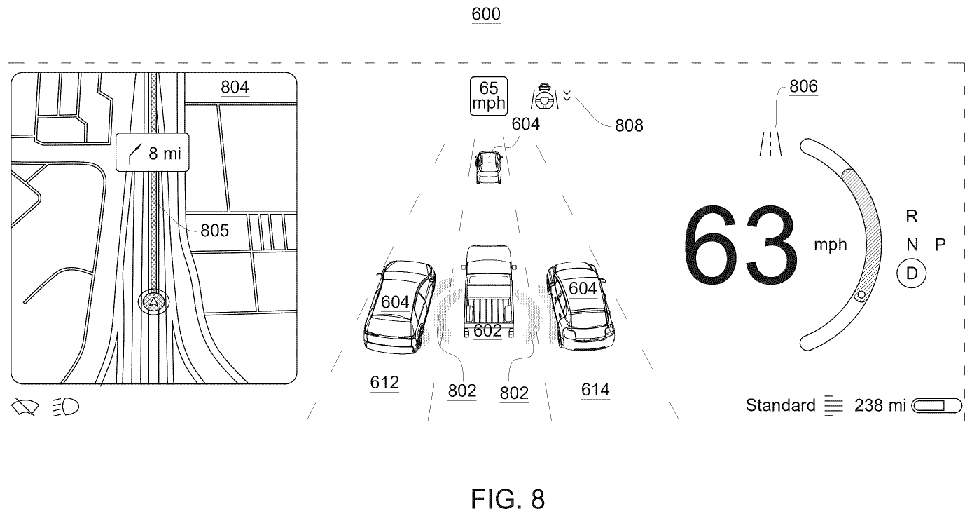

FIG. 8 depicts a graphical user interface, according to some aspects. The GUI may be depicted via a same or different display 600 as other instances of user interfaces 125 of the present disclosure. For example, a same display 600 can depict various elements of a user interface 125 responsive to an explicit selection of a display mode, an input received from a user or autonomy system (e.g., a turn signal indication), or a detected condition such as a presence of a vehicle or other object, lanes, etc. Different displays 600 may be used to selectively display a particular GUI, or particular elements thereof. For example, any of the GUIs depicted herein, or various elements thereof, can be displayed via an ICD, CID, or other vehicle display. One or more instances of a computing system, such as a data processing system 100, can generate the elements of the user interface 125 provided via the display 600.

The display 600 can include an ego vehicle 602 along with adjoining vehicles 604 in adjacent lanes 612, 614. An indication of detection 802 can depict a presence of a detected object in a field of view of a sensor 105. For example, the indication of detection 802 can be provided to indicate a detection of any object, or a classification of the object (e.g., motorized vehicle, VRU, or traffic control device such as a traffic cone). A user interface 125 of a vehicle can include any number of indications (e.g., an LED or audible alert of a vehicle in a blind spot), such that the indication may be provided via the display 600 or other indicator. A navigational window 804 depicts a planned route 805 of a vehicle. Further aspects of the display 600 can be based on the planned route 805. For example, a display 600 of an ego lane 610 can include a lane transition on a same roadway or a transition between roadways. Moreover, one or more selected primary object (PO) IDs 606 can depend on the planned route 805 (e.g., a current or predicted ego lane). For example, a PO ID 606 can be in a different lane from a vehicle where a vehicle path includes a lane change from the ego lane to the lance including the PO ID 606. GUI elements of the display 600 can depict the selected mode, such as via an indication of lane detection 806, or selected driving mode 808. For example, an autonomous or semiautonomous driving mode 808 can be shown as unselected according to a lack of a colored, highlighted, or other prominent display feature.

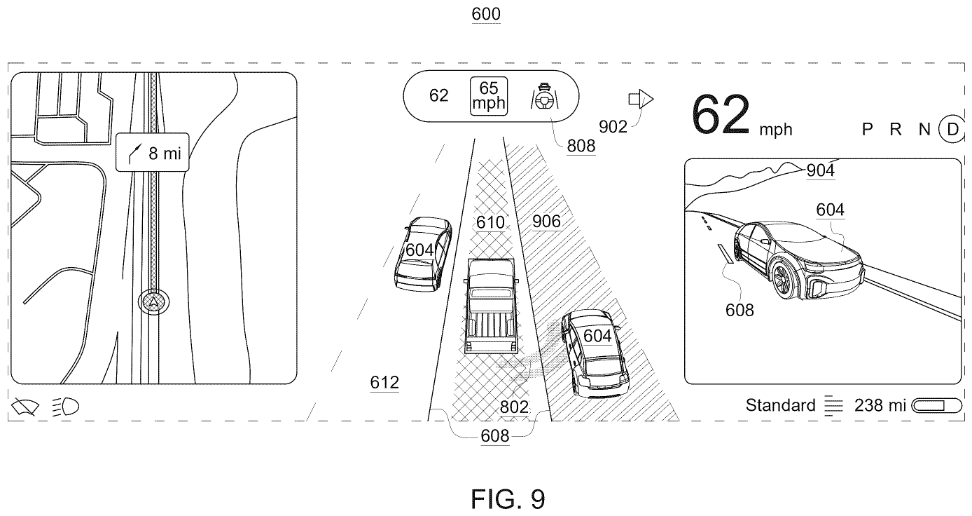

FIG. 9 depicts a graphical user interface 125, according to some aspects. The various elements of the GUI can be presented via the display 600. The GUI includes an indication of a planned lane changes 902 which is presented responsive to an indication of a path. The indication of the planned lane changes 902 can be received from a user (e.g., via actuation of a turn stalk signal) or from an autonomy system, in response to an environment including detected or otherwise ingested objects and roadways. For example, the environment can include information as received in a map or detected in sensor data 140 generated by a sensor 105 and processed in a birds eyed view (BEV) or other state space (e.g., from a single sensor or a BEV state space for fused sensor). In some cases, the lane change is provided responsive to a planned route (e.g., moving into or out of a passing lane related to as passing maneuver, or to access a left or right exit).

Various elements of the GUI can be provided responsive to the receipt of the planned lane change 902. For example, the data processing system 100 can be configured to provide the various elements of the GUI responsive to the receipt of the indication of the lane change. The data processing system 100 can provide, via the GUI, an indication of detection 802 with elevated prominence responsive to the planned lane changes 902. The data processing system 100 can provide, via the GUI, the ego lane 610 relative to lane markings 608. Particularly, the ego lane 610 is shown as centered between the lane markings 608. The lane markings 608 can be shown based on aspects of the environment. The lane markings 608 can be shown as solid to indicate a lack of lane change availability according to a dynamic environment (e.g., the other vehicles 604), even where the lane markings differ from such a view. For example, as shown in a camera view 904, a lane marking 608 indicating allowable lane changes can be depicted as not allowing lane changes responsive to the detection of a vehicle 604. The data processing system 100 can provide, via the GUI, a lane of interest 906 as restricted according to the detection of the vehicle 604 (e.g., the vehicle depicted in the camera view 904) as detected according to a camera or any other sensor of the various sensors 105 of a vehicle.

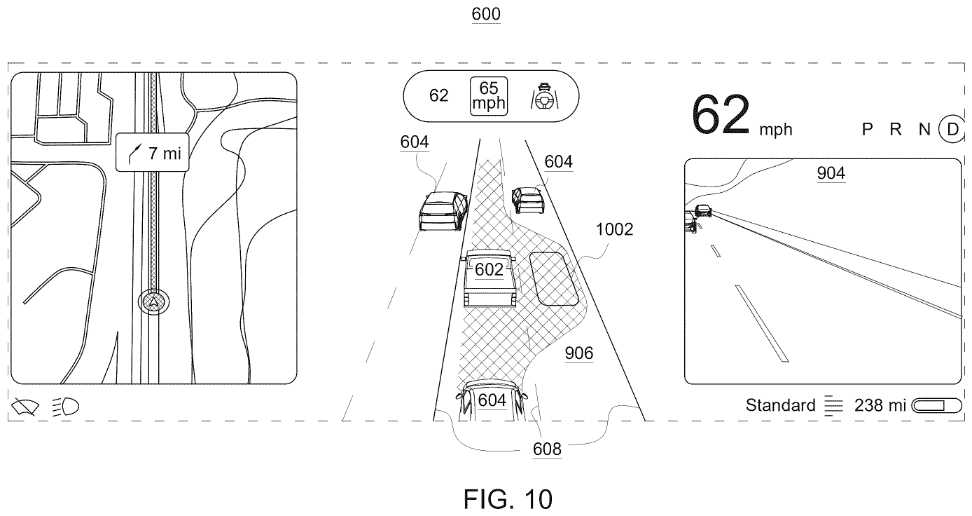

FIG. 10 depicts a graphical user interface, according to some aspects. A display 600 providing the elements of the GUI can, according to an operation of the data processing system 100, depict a lane of interest 906 which is available for the ego vehicle 602 to occupy. For example, a destination 1002 in the lane of interest 906 is shown as available for the vehicle to occupy. The destination 1002 can be provided relative to the ego vehicle 602 or other vehicle 604 in a same environment, such that the destination can be shown as moving relative to an environment including the roadway or other objects.

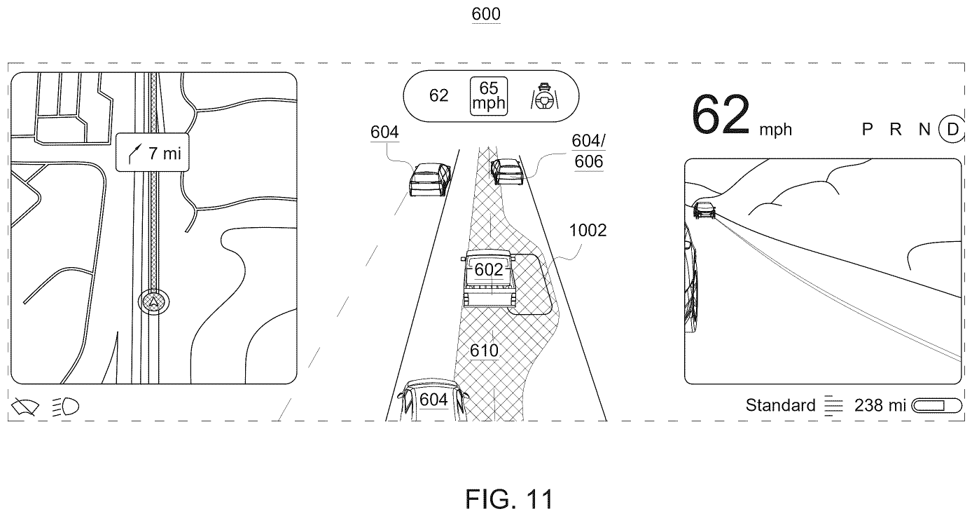

In FIG. 11, the ego lane 610 is shown transitioning between lane markings 608. The data processing system 100 can cause the display of the ego lane 610 to traverse lane markings so as to occupy portions of multiple lanes. This display can include lane marking 608 GUI elements for a combination of lanes which the vehicle occupies, as illustrated with elevated prominence. A lane marking 608 showing a lane-to-lane demarcation is further depicted lacking the elevated prominence. One or more primary object IDs 606 can be selected in a lane the ego vehicle 602 is departing from or entering.

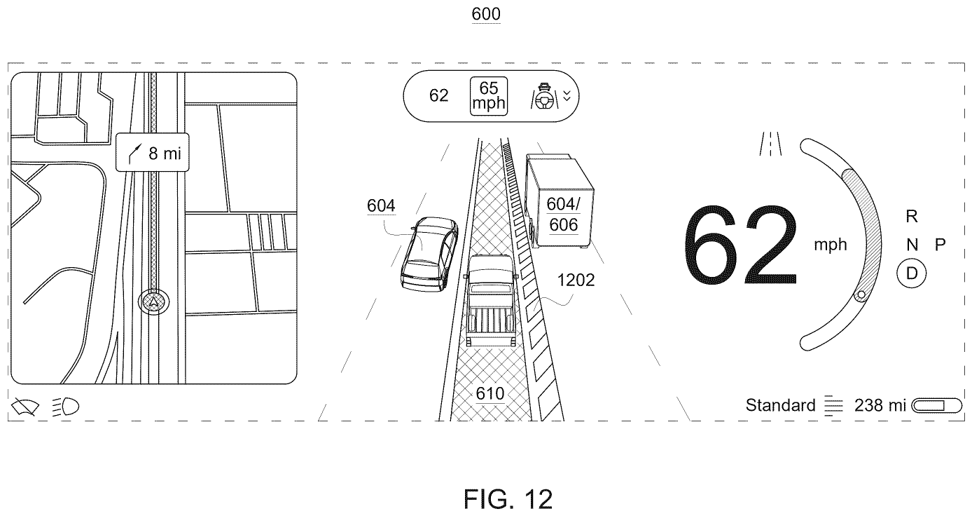

FIG. 12 depicts a graphical user interface, according to some aspects. Like the other instances of graphical user interfaces of the present disclosure, the graphical user interface can be generated by the data processing system 100. An ego lane 610 is depicted as a fractional portion of a lane as defined by lane markings 608 corresponding to and depicted by an approximation of physical roadway markings. For example, a restricted portion 1202 of a roadway lane corresponding to the ego lane 610 can be depicted as an element of the GUI. The restricted portion 1202 can correspond to an area identified for avoidance by an autonomy system, such as a lane keep assistance system (LKAS) or route planner. The restricted portion 1202 can be generated, identified, displayed, or used for the autonomy system responsive to a detection of a vehicle 604 or other object or classification thereof (e.g., as a tunnel wall or construction barrier).

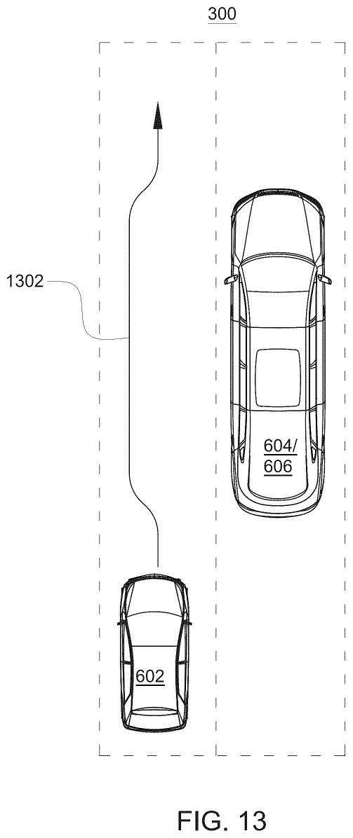

A data processing system 100 can generate, identify, display, or use the restricted portion 1202 based on a priority object ID 606 (e.g., a classification of the priority object ID 606, a size of the priority object ID 606 to a threshold size, or a position of the priority object ID 606 relative to a threshold position, such as where the priority object ID 606 corresponds to a vehicle encroaching the ego lane 610). Such an object is sometimes referred to as a standoff object. One or more classifications of a standoff object can correspond to a standoff distance, as may vary according to a speed of the ego vehicle 602, the standoff object, or a relative speed therebetween. For example, the data processing system 100 can generate a restricted portion 1202 to cause the vehicle to offset away from another vehicle, a wall, or a VRU. An autonomy system of the ego vehicle 602 can center the vehicle in the ego lane 610 exclusive of the restricted portion 1202 to cause the ego vehicle 602 to avoid encroaching the proximal object. When the ego vehicle 602 is no longer aside the priority object ID 606, the data processing system 100 can identify an ego lane 610 without a restricted portion 1202, to cause the ego vehicle 602 to proceed along the route 1302 depicted in the top view 300 of FIG. 13, avoiding the priority object 606. Such a selection of a route 1302 may aid vehicle occupant comfort due to avoiding proximity with large objects, and increase a time for the ego vehicle 602 to react to any actions by the other object, wind gusts, or other changing conditions.

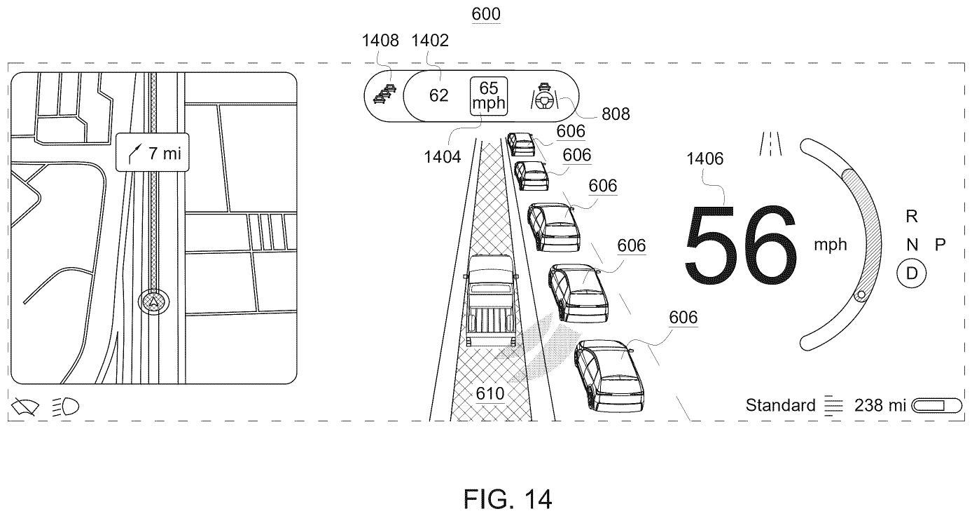

Referring to FIG. 14, a graphical user interface depicts an ego vehicle 602 having a selected autonomous or semiautonomous driving mode 808, according to some aspects. The GUI can present an indication of the driving mode 808 with increased prominence upon its selection. The autonomous or semiautonomous driving mode 808 can include speed control based on any of a selected speed 1402 (sometimes referred to as a vehicle target speed), speed limit 1404, or other aspects of an environment. The selected speed 1402 can include a user selection of a speed or a speed selected by an autonomy system (e.g., according to a vehicle range or vehicle efficiency). The speed limit 1404 may be identified according to predefined map data or from a vehicle sensor 105 (e.g., camera, vehicle-to-vehicle communications, or vehicle-to-infrastructure communications).

The autonomy system can implement a speed of travel 1406 based on aspects of an environment. The ego vehicle 602 can select a speed of travel 1406 based on a speed of other objects, such as a primary object IDs 606. For example, where traffic in a lane adjoining an ego lane 610 is slowed, the ego vehicle 602 can reduce a speed below a selected speed or raise a speed above a selected speed to reduce a speed differential between lanes. The display 600 can include an element indicating a presence of adjoining traffic 1408 to indicate a reason for the variance between the selected speed and the speed commanded or otherwise effected by the drive system. The display of the presence of adjoining traffic 1408 or the change in speed (e.g., the value of the speed differential) can be provided responsive to the classification of vehicles 604 in the adjoining lane. For example, the data processing system 100 can adjust a speed responsive to a class of vehicle or other object (e.g., VRU, other motorized vehicle, or construction equipment).

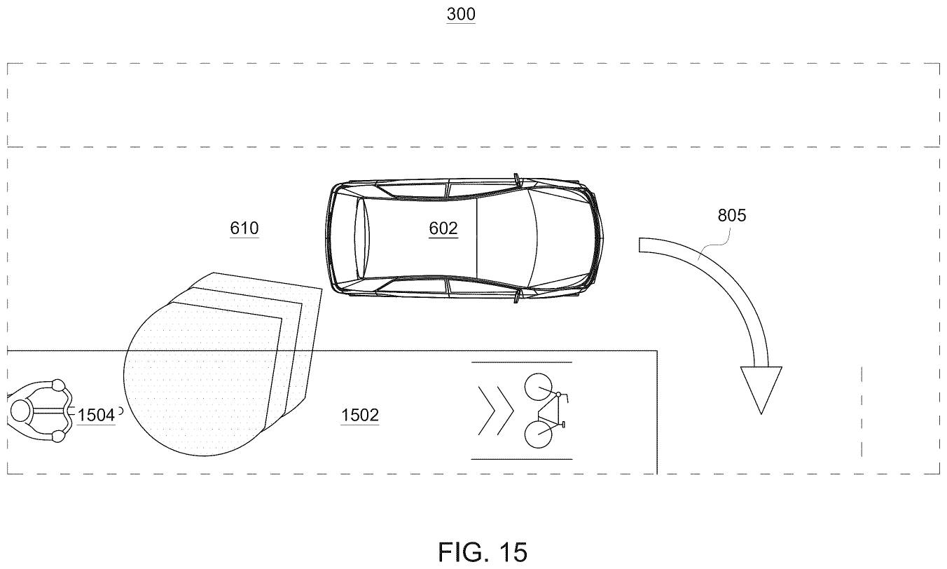

FIG. 15 is another top view 300 of an ego vehicle 602 (e.g., the electric vehicle 200 of FIG. 2) disposed in an environment, in accordance with some aspects. An intended route 805 for the vehicle 602 can intersect with a lane other than the ego lane 610, such as a bike lane 1502. A data processing system 100 of the ego vehicle 602 can detect a VRU (e.g., depicted as a bicyclist 1504), and provide an indication, to a user, of the presence of the bicyclist 1504. Such operation can correspond to an autonomous, semi-autonomous, or non-autonomous mode. For example, in a semiautonomous or autonomous mode, the data processing system 100 can adjust a speed of the vehicle upward or downward to reach an intersection between the intended route 805 and the bike lane 1502 a threshold time or distance from the bicyclist 1504. In a semi-autonomous, or non-autonomous mode, the data processing system 100 can depict a warning via a GUI element on the display 600 (or another indication) based on the intersection (e.g., simultaneous arrival) and the presence of the bicyclist 1504. The data processing system 100 can provide steering torque feedback to aid a driver to maintain the threshold time or distance from the bicyclist 1504.

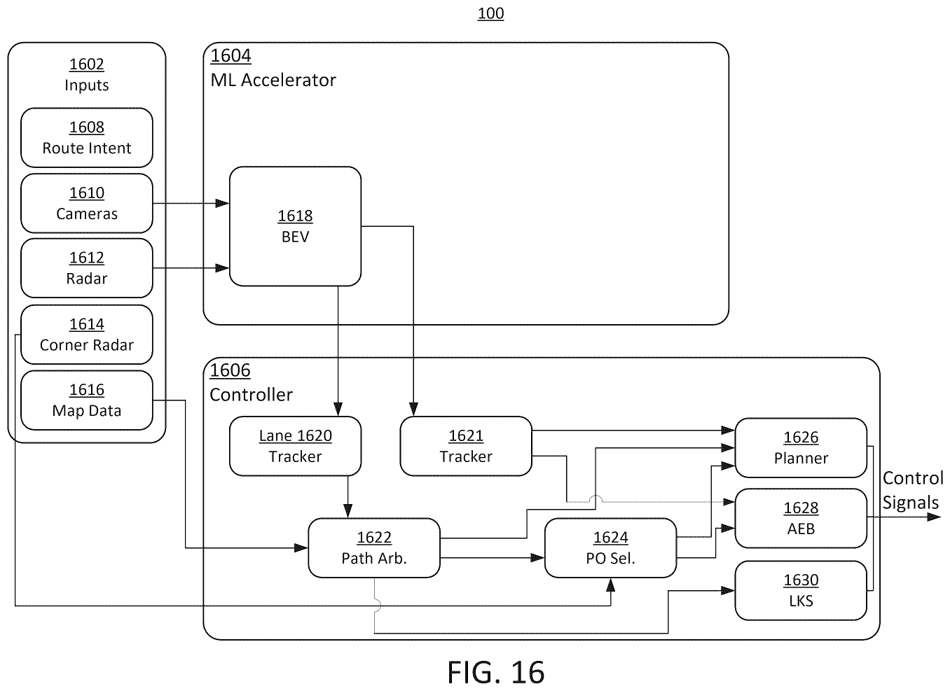

Referring generally to FIGS. 16-18, block diagrams of example data processing systems 100 are provided. The various block diagrams can refer to varying systems, or a phased transition to a machine learning (ML) accelerator implementation. The data processing system 100 or other implementations thereof can generate one or more elements of a GUI for display, or another component in communication with the data processing system 100 can generate the elements of the GUI based on information determined by the data processing system 100. For example, the data processing systems 100 of FIGS. 16-18 (or as otherwise disclosed herein) can generate any of the GUI instances depicted herein.

FIG. 16 is a block diagram for an example of a data processing system 100, according to some aspects. The data processing system 100 can include inputs 1602 which may be received by one or more controllers. For example, the inputs 1602 may be received by a first machine learning (ML) accelerator 1604 which may be implemented in a highly parallel environment such as a graphics processing unit (GPU) or ML specific hardware. Another controller 1606 can ingest outputs of the ML accelerator 1604 and provide, based on the outputs, control outputs to an autonomy system of a vehicle (e.g., generate control signals to effect navigational actions such as steering, braking, acceleration, or turn signal indications). The controller 1606 can operate according to deterministic instructions.

The data processing system 100 includes or interfaces with inputs 1602 including sensors 105 and predefined data. For example, the inputs 1602 can include an intended route 1608 received from a user or via a route generator to route a vehicle to a destination received from the user, or another predicted destination. The inputs 1602 can include camera data from any number of cameras 1610. The inputs can include radar data from any number of radar receivers 1612. For example, all radars of the data processing system 100 can be ingested into the ML accelerator 1604 (e.g., the bird's-eye-view 1618) and a portion of the radar data may be otherwise used, such as via the controller 1606 for path arbitration. A portion of radar data (e.g., from separate radar emitters 1612, 1614) can be provided to the ML accelerator 1604 and the controller 1606. The radar 1612 and corner radar 1614 can refer to sensors having overlapping, non-overlapping, or partially overlapping FOVs. Map data 1616 can include predefined information related to a roadway, which may be used to align or improve a confidence of sensed data, determine route pathing, and so forth. For example, the map data 1616 can include HD maps such as roadway data provided according to, for example, an open street map (OSM), GeoJSON, or Robot Operating System (ROS) map format.

The inputs can be ingested by a sensor fusor as may be configured to generate a bird's-eye-view (BEV) state space transform for a model 1618 or another model. For example, the data processing system can ingest the sensor data according to a data flow (e.g., the data flow of the block diagrams 400, 500 of FIG. 4 or 5), where the data flow is configured to generate object tracking information. Ingested signal information can include camera data and radar data, or data from any other sensors data available to a system. The BEV 1618 can include a top-down view of the world with a local map and visible tracks. The tracks can include a lane of travel or portion thereof, or lanes of a road (e.g., according to lane markings thereupon, map data, or flow data of other objects, such as other vehicles). The data processing system 100 can include or interface with various cross checkers external to the BEV 1618 to validate any information of the BEV model 1618. The ML accelerator 1604 can fuse any of the various inputs (e.g., data from cameras 1610 and radar 1612) and provide an output to an environmental tracker such as a lane tracker 1620 or another tracker 1621 to track any object in or associated with an environment.

A path arbitrator 1622 can select a route description (e.g., according to a selection of polynomial coefficients, such as parameters for a cubic spline function or segment thereof). The path arbitrator 1622 can consume polylines and fit them to the coefficients. Various components using the coefficients can separately calculate the coefficients or share a calculated coefficient upon a determination by a first component. A lane keep system 1630 can receive an indication of the route to cause a generation of control signals to cause a display, haptic feedback or other indication of lane departure, or to generate control signals to maintain a lane (e.g., control signals to adjust or maintain a steering angle).

A primary object selector 1624 can select one or more objects relevant to an ego vehicle 602 based on stored route data of a route received from the path arbitrator 1622. For example, a vehicle or other object in or adjacent to the route may be selected. The reference to a “primary” object should not be construed as limiting the PO ID 606 to a single object. Some instances of operation can select a single PO ID 606; some instances of operation can select multiple PO IDs 606. For example, a PO ID 606 may be selected according to a comparison of a relevance to an ego vehicle 602, the relevance determined based on a size, heading, position, or classification of the object or the ego vehicle 602. The primary object selector 1624 or other components (e.g., an automatic braking system, AEB 1628) can receive input data separate from the ML accelerator 1604. For example, the primary object selector 1624 can receive corner radar data to indicate a presence of vehicles in adjoining lanes, such as to avoid proximity to large vehicles (e.g., to offset an ego lane 610 within a lane). The provision of the separate data can aid some components to function even in the absence of some sensor data or of the ML accelerator 1604 generally.

An AEB system 1628 can receive information from an object tracker 1621 or primary object selector 1624. The AEB 1628 can receive an indication of objects which may intersect with an ego vehicle 602 to determine an application of braking to prevent the intersection (e.g., collision avoidance). For example, the AEB system can determine an intersection between a predicted path for the ego vehicle 602 with a predicted path (e.g., a static location or extrapolation based on a current speed or direction of travel) for another object. A planner 1626 can include a route planner which can control vehicle operation in an absence of an AEB 1628 or LKS 1630 operation. For example, the planner 1626 can cause the vehicle to proceed along a route based on BEV data (e.g., lane selection, position within a lane, or speed selection).

The data processing system 100 or components thereof can operate in a shadow mode to gather operational data for comparison to another control system component, or in an active mode to effect the generation of displays or control signals to cause navigational actions.

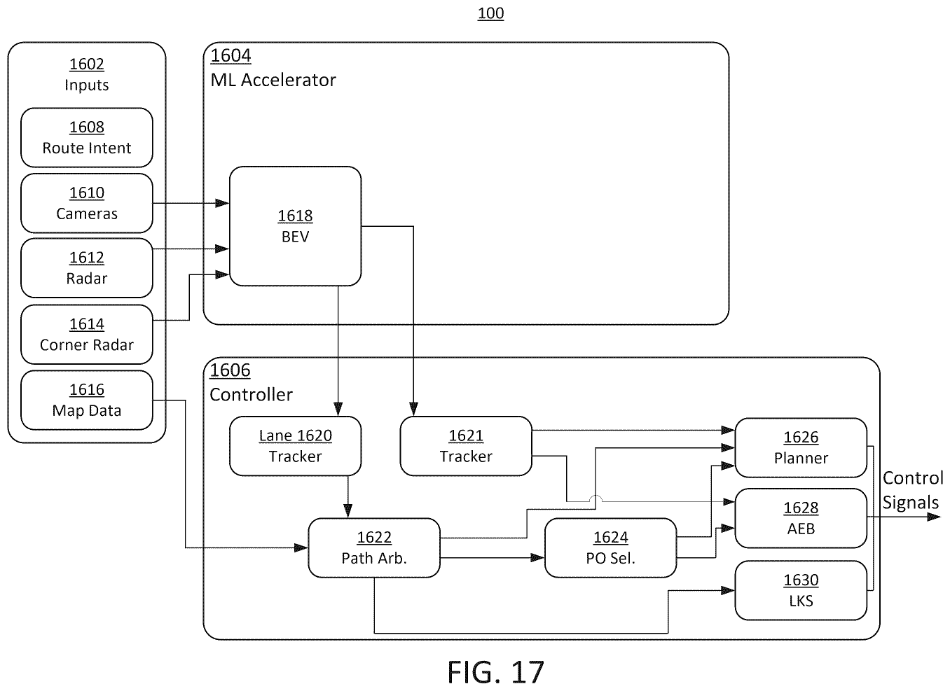

FIG. 17 is a block diagram for an example of a data processing system 100, according to some aspects. The BEV 1618 receives inputs 1602 of sensor data 140 including the corner radar data. The PO selector 1624 can omit the input to cause the dataflow of the data to pass through the lane tracker 1620 or other tracker 1621 and on the planner 1626, AEB 1628, or LKS 1630.

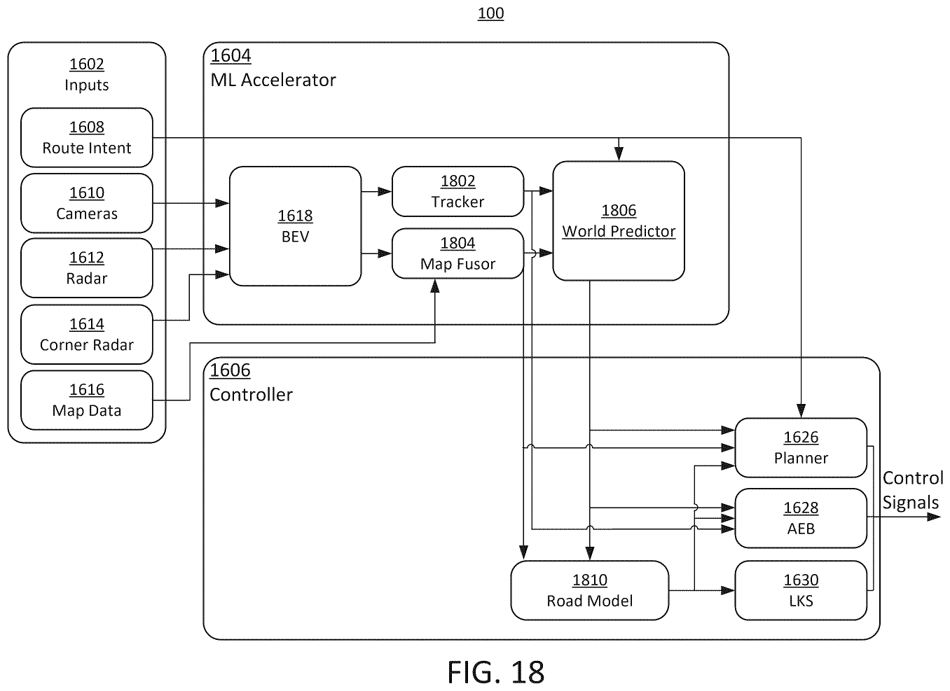

FIG. 18 is a block diagram for an example of a data processing system 100, according to some aspects. The block diagram depicts additional functionality realized in the ML accelerator 1604. For example, a ML tracker 1802 can track or identify various objects, lane markings, and other aspects of the environment. A map fusor 1804 can fuse map data 1616 with other inputs 1602. The tracker 1802 and map fusor 1804 can output data to a world predictor 1806 to predict a current or future state of an environment. The world predictor 1806 can provide aspects of the predicted environment to the controller 1606 to control signal generation. For example, the world predictor 1806 can generate outputs for a road model 1810, planner 1626, and AEB system 1628.

The road model 1810 can, based on data received from the tracker 1802 and the world predictor 1806, generate determinative outputs for the LKS 1630, AEB, 1628, and planner 1626. For example, the road model 1810 can model a roadway including tracked objects (e.g., including a flow or occupancy of the environment) and predictions of the world predictor 1806. An AEB 1628 can generate control signals for braking based on the tracker 1802, world predictor 1806, and road model 1810. An LKS 1630 can operate based on the road model 1810. Such operation can include generating the depictions of the graphical user interface (e.g., any of the elements provided herein) or control signals to keep the ego vehicle 602 to an ego lane (which can correspond to a marked lane, a subset thereof, or combinations of multiple lanes).

Components of the ML accelerator 1604 may be implemented as distinct components having discrete inputs and outputs, or according to a unified model. For example, a model can operate as an end-to-end model including each of the depicted components (e.g., outputting vehicular control signals based on the inputs), include other combinations of components, or the various components can be implemented be a same model or component of a model. The illustrative examples of objects provided according to an ML accelerator 1604 or another controller 1606 (e.g., deterministic model or algorithm) should not be construed as limiting. Various functionality can be implemented according to various components, or can be omitted, supplemented, or substituted with different components.

A method of perception information visualization is provided, according to some aspects. The method can be performed by one or more systems or components depicted in FIGS. 1-18 including the data processing system 100. For example, the method can be performed by one or more controllers of an electric vehicle 200, having a memory device communicatively coupled therewith.

The various operations of the method can include ACTs provided henceforth can inherit, duplicate, or adapt various aspects described throughout the present disclosure.

The method can include an ACT of receiving, from a first plurality of sensors of a first sensor type, first sensor data. The method can include an ACT of receiving, from a second plurality of sensors of a second sensor type, second sensor data. The method can include generating, based on the first sensor data and the second sensor data, an environmental map. The method can include an ACT of identifying, based on the environmental map, a plurality of objects and an indication of a route. The method can include classifying the plurality of objects and the route. The method can include an ACT of displaying, based on the classification, a plurality of first visual representations corresponding to the plurality of objects a second visual representation based on the route.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors 105 providing any value determined herein, sensors 105 providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system comprising one or more processors coupled with memory, the system to:
receive, from a first plurality of sensors of a first sensor type, first sensor data;
receive, from a second plurality of sensors of a second sensor type, second sensor data;
generate, based on the first sensor data and the second sensor data, an environmental map;
identify, based on the environmental map, a plurality of objects and an indication of a route;
classify the plurality of objects and the route; and
display, based on the classification, of a plurality of first visual representations corresponding to the plurality of objects and a second visual representation based on the route.

2. The system of claim 1, comprising the system to generate the environmental map according to a fusion of:
first features extracted from the first sensor data; and
second features extracted from the second sensor data,
wherein the identification of the plurality of objects is based on third features extracted from the environmental map.

3. The system of claim 1, wherein the identification of the route comprises:
an identification of a lane marking; and
a flow of one or more of the plurality of objects.

4. The system of claim 1, wherein the plurality of first visual representations corresponding to the classification comprises at least one first visual representation for:
a pedestrian;
a vulnerable road user;
a motorized vehicle; and
a traffic control device.

5. The system of claim 1, comprising the system to:
validate, subsequent to an identification and prior to the display of the plurality of objects and the indication of the route, a position of the plurality of objects and the route, the validation according to a temporal dependency between the position and a previous position.

6. The system of claim 1, wherein the first sensor type and the second sensor type is an optical camera.

7. The system of claim 1, wherein the first sensor type is an optical camera and the second sensor type is one of an ultrasonic sensor, a radar sensor, or a LiDAR sensor.

8. The system of claim 1, comprising the system to:
update, periodically, the identification of the plurality of objects; and
update the identification of the indication of the route asynchronously to the update of the identification of the plurality of objects.

9. The system of claim 1, wherein:
identifying the plurality of objects comprises identifying a first object of the plurality of objects in a same lane and forward of a vehicle comprising the first plurality of sensors and the second plurality of sensors; and
depicting the plurality of first visual representations corresponding to the first object with elevated prominence relative to the other of the plurality of objects.

10. The system of claim 1, wherein the display of the first visual representations and the second visual representation is based on a receipt of a user selection of a driving mode.

11. The system of claim 1, comprising the system to:
detect an omission of the first sensor data; and
generate, responsive to the detection of the omission, the environmental map based on the second sensor data.

12. The system of claim 1, comprising the system to classify the route based on at least one of stored route data or a global navigation satellite system (GNSS) sensor.

13. The system of claim 1, comprising the system to:
encode the first sensor data into a first data structure;
extract first features from the first data structure;
encode the second sensor data into a second data structure;
extract second features from the second data structure; and
generate the environmental map using the first features and the second features.

14. A vehicle comprising:
an in-cabin display; and
one or more processors coupled with memory, to:
receive, from a first plurality of sensors of a first sensor type, first sensor data;
receive, from a second plurality of sensors of a second sensor type, second sensor data;
generate, based on the first sensor data and the second sensor data, an environmental map;
identify, based on the environmental map, a plurality of objects and an indication of a route;
classify the plurality of objects and the route; and
present on the in-cabin display, based on the classification, of a plurality of first visual representations corresponding to the plurality of objects and a second visual representation based on the route.

15. The vehicle of claim 14, further comprising the one or more processors to:
execute a navigational action responsive to the plurality of the objects and the indication of the route identified based on the environmental map.

16. A method comprising:
receiving, by one or more processors, from a first plurality of sensors of a first sensor type, first sensor data;
receiving, by the one or more processors from a second plurality of sensors of a second sensor type, second sensor data;
generating, by the one or more processors, based on the first sensor data and the second sensor data, an environmental map;
identifying, by the one or more processors based on the environmental map, a plurality of objects and an indication of a route;
classifying, by the one or more processors, the plurality of objects and the route; and
displaying, by the one or more processors, based on the classification, a plurality of first visual representations corresponding to the plurality of objects a second visual representation based on the route.

17. The method of claim 16, comprising:
classifying, by the one or more processors, an object of the plurality of objects as a standoff object;
displaying, by the one or more processors based on the classification of the standoff object, an ego lane in a subset of an area between lane markings corresponding to the ego lane; and
displaying, by the one or more processors based on the classification of the standoff object, a restricted portion of the area.

18. The method of claim 16, comprising:
receiving, by the one or more processors, an indication of a lane change;
determining, by the one or more processors, an occupancy of a lane adjacent to an ego lane; and
displaying, by the one or more processors, a destination in the adjacent lane.

19. The method of claim 16, comprising:
receiving, by the one or more processors, an indication of a vehicle target speed;
identifying, by the one or more processors, a speed of a portion of the plurality of objects in an adjacent lane to an ego lane; and
adjusting, by the one or more processors, the vehicle target speed to reduce a difference between the vehicle target speed and a speed associated with the portion of the plurality of objects.

20. The method of claim 16, comprising:
determining an intersection between an ego lane and a second lane; and
presenting an indication of the intersection prior to arrival at the intersection based on a detection of a vulnerable road user in the second lane.
